(19) United States
(12) Patent Application Publication
(10) Pub. No.: US 2026/0259847 A1
(43) Pub. Date: Sep. 3, 2026

(54) DEVICE AND METHOD FOR MIXING AND TRANSMITTING AUDIO SIGNAL AND HID SIGNAL IN SHORT-RANGE WIRELESS COMMUNICATION SYSTEM

(71) Applicant: LG Electronics Inc., Seoul (KR)

(72) Inventors: Hyeonjae LEE, Seoul (KR); Jongmin KIM, Seoul (KR)

(21) Appl. No.: 19/474,379

(22) PCT Filed: Apr. 11, 2024
(86) PCT No.: PCT/KR2024/004856

§ 371 Date: Oct. 10, 2025

(30) Foreign Application Priority Data
Apr. 11, 2023 (KR) 10-2023-0047673

(51) Int. Cl. G06F 13/42; G06F 3/16

(52) U.S. Cl. CPC G06F 13/42; G06F 3/162

(57) ABSTRACT

The present disclosure provides a device and a method for mixing and transmitting an audio signal and an HID signal in a short-range wireless communication system. The present disclosure provides a device and a method for transmitting an audio signal with a length less than ½ of a sub-interval and transmitting an HID signal after an offset corresponding to ½ of the sub-interval, so as to transmit audio signals and HID signals mixed without overlapping each other.

### TECHNICAL FIELD

The present disclosure relates to a device and a method for mixing and transmitting an audio signal and an HID signal in a short-range wireless communication system. Particularly, the present disclosure relates to a device and a method for mixing and transmitting an audio signal and an HID signal without overlap by transmitting the audio signal for a length less than ½ of a sub-interval and transmitting the HID signal after an offset corresponding to ½ of the sub-interval.

### BACKGROUND ART

When a user plays a game, a game controller (peripheral device or slave device) is connected to a game console (central device, host device, or master device) to enjoy the game, and in this case, an input delay occurs depending on a connection scheme between the game controller and the game console. Further, an audio output delay occurs depending on a connection scheme between a headset and the game console.

In the case of wired controllers and wired headsets, delay and jitter due to the connection scheme are nearly 0 ms, and most delays are merely delays due to software (SW) processing.

In the case of the wireless controllers and the wireless headsets, delays occur due to a wireless connection scheme, resulting in a time delay and the jitter.

Wireless controllers using a Bluetooth BR/EDR standard scheme experience delays and jitter due to a 12.5 ms polling scheme which is a standard recommended specification. Further, audio using a BR/EDR standard scheme using SBC codec experiences a time delay of approximately 150 to 200 ms due to the use of an input/output buffer caused by a network delay.

Moreover, when multiple users are connected, variation ranges of the delay and the jitter become greater due to an asynchronous wireless connection scheme.

### DISCLOSURE

### Technical Problem

In order to solve the above-described problem, the present disclosure provides a device and a method for mixing and transmitting an audio signal and an HID signal in a short-range wireless communication system.

The present disclosure provides a device and a method for mixing and transmitting an audio signal and an HID signal without overlap by transmitting the audio signal for a length less than ½ of a sub-interval and transmitting the HID signal after an offset corresponding to ½ of the sub-interval.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

According to various embodiments of the present disclosure, provided is an operation method of a first device in a short-range wireless communication system, in which the first device includes: a first processor corresponding to a host stack; a second processor corresponding to a first controller stack; a memory; and a transceiver, and the host stack and the controller stack are connected via a Host Controller Interface (HCI), and the method includes: generating two second audio signals based on one first audio signal; transmitting, to a second device, each of a plurality of first periodic audio signals consisting of two second audio signals and duplicate signals for the two second audio signals, sequentially from a first anchor point of a first interval at each sub-interval length; and transmitting a human interface device (HID) signal to the second device repeatedly at each sub-interval length from a second time point at which an offset from the first anchor point has elapsed, in which each of the plurality of first periodic audio signals and the HID signal are not transmitted while being overlapped with each other.

According to various embodiments of the present disclosure, provided is an operation method of a second device in a short-range wireless communication system, wherein the second device includes: a first processor corresponding to a host stack; a second processor corresponding to a second controller stack; a memory; and a transceiver, and the host stack and the controller stack are connected via a Host Controller Interface (HCI), and the method includes: receiving, from a first device, each of a plurality of first periodic audio signals consisting of two second audio signals and duplicate signals for the two second audio signals, sequentially from a first anchor point of a first interval at each sub-interval length, in which the second audio signals are based on one first audio signal, and receiving a human interface device (HID) signal from the first device repeatedly at each sub-interval length from a second time point at which an offset from the first anchor point has elapsed, in which each of the plurality of first periodic audio signals and the HID signal are not transmitted while being overlapped with each other.

According to various embodiments of the present disclosure, provided is a first device in a short-range wireless communication system, which includes: a first processor corresponding to a host stack; a second processor corresponding to a first controller stack; a memory; and a transceiver, in which the host stack and the controller stack are connected by a Host Controller Interface (HCI), the memory stores instructions for performing operations based on being executed by the first processor and the second processor, and the operations include generating two second audio signals based on one first audio signal; transmitting, to a second device, each of a plurality of first periodic audio signals consisting of two second audio signals and duplicate signals for the two second audio signals, sequentially from a first anchor point of a first interval at each sub-interval length; and transmitting a human interface device (HID) signal to the second device repeatedly at each sub-interval length from a second time point at which an offset from the first anchor point has elapsed, and in which each of the plurality of first periodic audio signals and the HID signal are not transmitted while being overlapped with each other.

### Advantageous Effects

In order to solve the above-described problem, the present disclosure can provide a device and a method for mixing and transmitting an audio signal and an HID signal in a short-range wireless communication system.

The present disclosure can provide a device and a method for mixing and transmitting an audio signal and an HID signal without overlap by transmitting the audio signal for a length less than ½ of a sub-interval and transmitting the HID signal after an offset corresponding to ½ of the sub-interval.

### DESCRIPTION OF DRAWINGS

The accompanying drawings, which are to provide a further understanding of the present disclosure, can provide embodiments of the present disclosure together with the detailed description. However, technical features of the present disclosure are not limited to specific drawings and features disclosed in the respective drawings may be combined with each other to constitute a new embodiment. Reference numerals in each drawing may refer to structural elements.

FIG. 1 is a schematic view illustrating an example of a wireless communication system using a Bluetooth low energy technology to which the present disclosure is applicable.

FIG. 2 illustrates an example of an internal block diagram of a device capable of implementing methods proposed by the present disclosure.

FIG. 3 illustrates an example of a Bluetooth communication architecture to which methods proposed by the present disclosure may be applied.

FIG. 4 illustrates an example of a structure of a generic attribute profile (GATT) of Bluetooth low energy.

FIG. 5 is a flowchart showing an example of a connection procedure method in Bluetooth low energy technology to which the present disclosure may be applied.

FIG. 6 illustrates an example of a process in which a central (host device or master device) and a peripheral device (slave device) sends and receives a signal to and from each other in a time domain.

FIG. 7 illustrates an example of a process in which a central (host device or master device) and a peripheral device (slave device) sends and receives a signal to and from each other in a time domain.

FIG. 8 illustrates an example of a configuration of a signal transmitted between the central device (host device or master device) and the peripheral device (slave device) in the time domain.

FIG. 9 illustrates an example of a configuration of the signal transmitted between the central device (host device or master device) and the peripheral device (slave device) in the time domain.

FIG. 10 illustrates an example of a configuration of the signal transmitted between the central device (host device or master device) and the peripheral device (slave device) in the time domain.

FIG. 11 illustrates an example of a configuration of the signal transmitted between the central device (host device or master device) and the peripheral device (slave device).

FIG. 12 illustrates an example of a configuration of the signal transmitted between the central device (host device or master device) and the peripheral device (slave device).

FIG. 13 illustrates an example of a configuration of the signal transmitted between the central device (host device or master device) and the peripheral device (slave device).

FIG. 14 illustrates an example of a configuration of the signal transmitted between the central device (host device or master device) and the peripheral device (slave device).

FIG. 15 illustrates an example of a configuration of the signal transmitted between the central device (host device or master device) and the peripheral device (slave device).

FIG. 16 illustrates an example of a configuration of the signal transmitted between the central device (host device or master device) and the peripheral device (slave device).

FIG. 17 illustrates an example of a configuration of the signal transmitted between the central device (host device or master device) and the peripheral device (slave device).

FIG. 18 illustrates an example of a configuration of the signal transmitted between the central device (host device or master device) and the peripheral device (slave device).

FIG. 19 illustrates an example of a stack of Bluetooth Low Energy (BLE).

FIG. 20 illustrates an example of a configuration of the signal transmitted between the central device (host device or master device) and the peripheral device (slave device).

FIG. 21 illustrates an example of a configuration of a signal transmitted between the central device (host device or master device) and the peripheral device (slave device) in the time domain.

FIG. 22 illustrates an example of a configuration of a signal transmitted between the central device (host device or master device) and the peripheral device (slave device) in the time domain.

FIG. 23 illustrates an example of a configuration of the central device (host device or master device) and the peripheral device (slave device) in the time domain according to various embodiments of the present disclosure.

FIG. 24 illustrates an example of a configuration of a signal transmitted between the central device (host device or master device) and the peripheral device (slave device) according to various embodiments of the present disclosure.

FIG. 25 illustrates an example of a configuration of the signal transmitted between the central device (host device or master device) and the peripheral device (slave device) in the time domain according to various embodiments of the present disclosure.

FIG. 26 illustrates an example of a configuration of the signal transmitted between the central device (host device or master device) and the peripheral device (slave device) in the time domain according to various embodiments of the present disclosure.

FIG. 27 illustrates an example of a configuration of the signal transmitted between the central device (host device or master device) and the peripheral device (slave device) in the time domain according to various embodiments of the present disclosure.

FIG. 28 illustrates an example of an operation process of a wireless device in the short-range wireless communication system according to various embodiments of the present disclosure.

FIG. 29 illustrates an example of an operation process of a wireless device in the short-range wireless communication system according to various embodiments of the present disclosure.

### MODES FOR DISCLOSURE

In various embodiments of the present disclosure, “A or B” may mean “only A,” “only B,” or “both A and B”. In other words, “A or B” may be interpreted as “A and/or B” in various embodiments of the present disclosure. For example, in various embodiments of the present disclosure, “A, B or C” can mean “only A,” “only B,” “only C,” or “any combination of A, B, and C”.

A slash (/) or a comma used in various embodiments of the present disclosure may mean “and/or”. For example, “A/B” may mean “A and/or B”. Accordingly. “A/B” may mean “only A,” “only B,” or “both A and B”. For example, “A, B, C” may mean “A, B, or C”.

In various embodiments of the present disclosure, “at least one of A and B” may mean “only A,” “only B,” or “both A and B”. Further, in various embodiments of the present disclosure, the expression “at least one of A or B” or “at least one of A and/or B” may be interpreted the same as “at least one of A and B”.

Further, in various embodiments of the present disclosure, “at least one of A, B and C” may mean “only A,” “only B,” “only C”, or “any combination of A, B and C”. Further, in various embodiments of the present disclosure, the expression “at least one of A, B or C” or “at least one of A, B and/or C” may be interpreted the same as “at least one of A, B and C”.

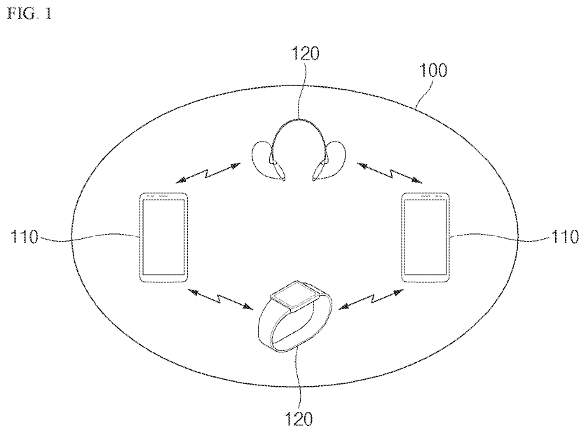

FIG. 1 is a schematic view illustrating an example of a wireless communication system using a Bluetooth low energy technology to which the present disclosure is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty. (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may be expressed as a data service device, a slave device, a slave, a server, a conductor, a host device, a gateway, a sensing device, a monitoring device, a first device, a second device, etc.

The client device 110 may be expressed as a master device, a master, a client, a member, a sensor device, a sink device, a collector, a third device, a fourth device, etc.

The server device and the client device correspond to main components of the wireless communication system and the wireless communication system may include other components other than the server device and the client device.

The server device refers to a device that receives data from the client device, communicates directly with the client device, and provides data to the client device through a response when receiving a data request from the client device.

Further, the server device sends a notice/notification message and an indication message to the client device in order to provide data information to the client device. In addition, when the server device transmits the indication message to the client device, the server device receives a confirm message corresponding to the indication message from the client device.

Further, the server device may provide the data information to a user through a display unit or receive a request input from the user through a user input interface in the process of transmitting and receiving the notice, indication, and confirm messages to and from the client device.

In addition, the server device may read data from a memory unit or write new data in the corresponding memory unit in the process of transmitting and receiving the message to and from the client device.

Further, one server device may be connected to multiple client devices and may be easily reconnected to the client devices by using bonding information.

The client device 120 refers to a device that requests the data information or data transmission to the server device.

The client device receives the data from the server device through the notice message, the indication message, etc., and when receiving the indication message from the server device, the client device sends the confirm message in response to the indication message.

Similarly, the client device may also provide information to the user through the display unit or receive an input from the user through the user input interface in the process of transmitting and receiving the messages to and from the server device.

In addition, the client device may read data from the memory unit or write new data in the corresponding memory unit in the process of transmitting and receiving the message to and from the server device.

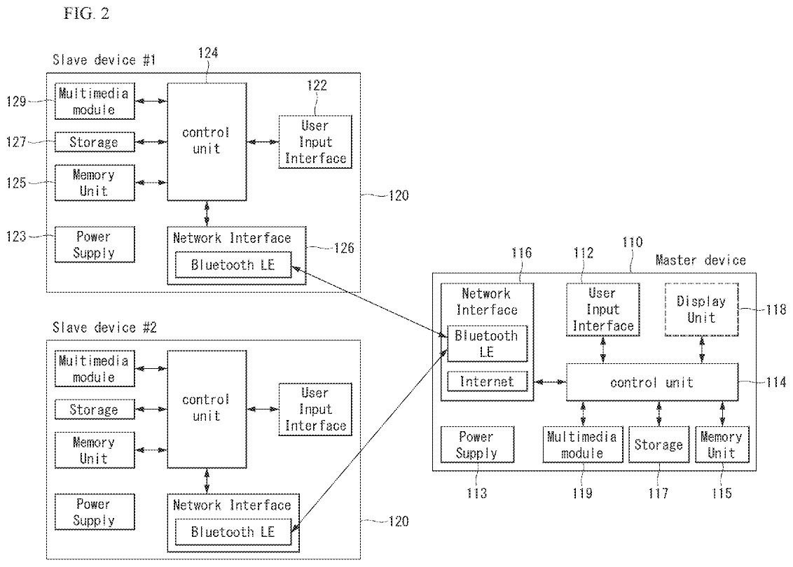

Hardware components such as the display unit, the user input interface, and the memory unit of the server device and the client device will be described in detail in FIG. 2.

Further, the wireless communication system may configure personal area networking (PAN) through Bluetooth technology. As an example, in the wireless communication system, a private piconet between the devices is established to rapidly and safely exchange files, documents, and the like.

FIG. 2 illustrates an example of an internal block diagram of a device capable of implementing methods proposed by the present disclosure.

As shown in FIG. 2, the master device 110 includes a user input interface 112, a power supply unit 113, a control unit 114, a memory unit 115), a network interface including a Bluetooth interface (Network Interface, 116), a storage (Storage, 117), an output unit (Display Unit, 118), and a multimedia module (Multi media Module, 119).

A network interface including the input unit (User Input Interface, 112), the power supply unit (Power Supply Unit, 113), the control unit (Control Unit, 114), the memory (Memory Unit, 115), and a Bluetooth interface (Bluetooth Interface) (Network Interface, 116), storage (Storage, 117), output unit (Display Unit, 118), and multimedia module (Multi media Module, 119) are functionally connected to each other to perform the method proposed in this specification.

In addition, as shown in FIG. 2, the slave devices (#1 and #2) 120 include an input unit (User Input Interface) 122, a power supply unit (Power Supply Unit) 123, a control unit (Control Unit, 124), memory (Memory Unit, 125), network interface (Network Interface, 126) including Bluetooth interface, storage (Storage, 127), output unit (Display Unit, 128), multi media module (Multi media Module, 129).

A network interface including the input unit (User Input Interface, 122), the power supply unit (Power Supply Unit, 123), the control unit (Control Unit, 124), the memory (Memory Unit, 125), and a Bluetooth interface (Bluetooth Interface) (Network Interface, 126), storage (Storage, 127), output unit (Display Unit, 128), and multimedia module (Multi media Module, 129) are functionally connected to each other to perform the method proposed in this specification.

The network interfaces 116 and 126 refer to units (or modules) capable of transmitting requests/responses, commands, notifications, instruction/confirmation messages, etc., or data between devices using Bluetooth technology.

The memories 115 and 125 are units implemented in various types of devices and refer to units in which various types of data are stored. Also, the storages 117 and 127 refer to units that perform a function similar to that of a memory.

The controllers 114 and 124 refer to a module that controls the overall operation of the master device 110 or the slave device 120, requests to transmit a message to a network interface, or controls to process a received message.

The controllers 114 and 124 may include an application-specific integrated circuit (ASIC), another chipset, a logic circuit, and/or a data processing device.

The memories 115 and 125 may include read-only memory (ROM), random access memory (RAM), flash memory, memory card, storage medium, and/or other storage devices.

The memories 115 and 125 may be inside or outside the processors 114 and 124, and may be connected to the processors 114 and 124 by various well-known means.

The output units 118 and 128 refer to modules for providing device status information and message exchange information to users through screens.

The power supply unit (power supply unit, 113, 123) refers to a module that receives external power and internal power under the control of the control unit and supplies power necessary for the operation of each component.

As discussed above, the BLE technology has a small duty cycle and can greatly reduce power consumption through a low data rate.

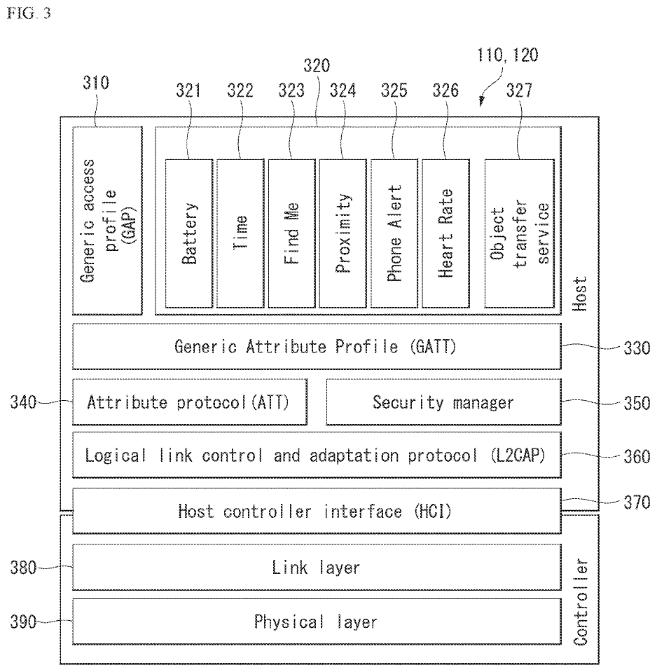

FIG. 3 illustrates an example of a Bluetooth communication architecture to which methods proposed by the present disclosure may be applied.

Specifically, FIG. 3 illustrates an example of an architecture of Bluetooth low energy (LE).

As shown in FIG. 3, the BLE structure includes a controller stack capable of processing a wireless device interface for which timing is critical and a host stack capable of processing high level data.

The controller stack may also be called a controller. In order to avoid confusion with the processor, that is, an internal element of the device described with reference to FIG. 2, however, the controller stack may be preferably used below.

First, the controller stack may be implemented using a communication module which may include a Bluetooth wireless device and a processor module which may include a processing device, such as a microprocessor.

The host stack may be implemented as part of an OS operating on the processor module or as a package instance on an OS.

In some cases, the controller stack and the host stack may operate or may be performed on the same processing device within the processor module.

The host stack includes a generic access profile (GAP) 310, GATT based profiles 320, a generic attribute profile (GATT) 330, an attribute protocol (ATT) 340, a security manager (SM) 350, and a logical link control and adaptation protocol (L2CAP) 360. The host stack is not limited to the aforementioned composition, but may include various protocols and profiles.

The host stack multiplexes various protocols and profiles provided by that Bluetooth disclosure using the L2CAP.

First, the L2CAP 360 provides one bilateral channel for sending data to according to a specific protocol or specific profile.

The L2CAP is capable of multiplexing data between upper layer protocols, segmenting or reassembling packages, and managing multicast data transmission.

BLE uses three fixed channels for respective signaling, a security manager, and an attribute protocol.

BR/EDR uses a dynamic channel and supports a protocol service multiplexer, retransmission, streaming mode.

The SM 350 authenticates a device, which is a protocol for providing a key distribution.

The ATT 340 relies on a server-client structure, which defines rules for a corresponding device for data access. Six message types are defined: Request, Response, Command, Notification, Indication, and Confirmation.

\textcircled{1} Request and Response message, the Request message is used when a client device requests specific information from a server device, and the Response message is used in response to a Request message, which is transmitted from the server device to the client device.

\textcircled{2} Command message: The Command message is transmitted from a client device to a server device in order to indicate a command for a specific operation, but the server device does not send a response to a Command message to the client device.

\textcircled{3} Notification message: A server device sends this message to a client device in order to provide notification of an event, but the client device does not send a confirmation message to the server device in response to a Notification message.

\textcircled{4} Indication and Confirm message: A server device sends this message to a client device in order to provide notification of an event. Unlike in the Notification message, the client device sends a Confirm message to the server device in response to an Indication message.

The generic access profile (GAP) is a layer newly implemented to support the BLE technology, and is used to control the selection of a role for communication between BLE devices and a multi-profile operation.

The GAP is mainly used for device discovery, connection establishment, and security. That is, the GAP defines a method for providing information to a user and also defines the following attribute types.

\textcircled{1} Service: A combination of actions related to data, and it defines the basic operation of a device.

\textcircled{2} Include: Define a relationship between services.

\textcircled{3} Characteristics: A data value used by a service

\textcircled{4} Behavior: A format that may be readable by a computer, which is defined by a Universal Unique Identifier (UUID) and a value type.

The GATT-based profiles are dependent on the GATT and are mainly applied to BLE devices. The GATT-based profiles may include Battery, Time, FindMe, Proximity, Object Delivery Service and so on. More specific descriptions of the GATT-based profiles are as follows.

Battery: A method for exchanging battery information.

Time: A method for exchanging time information.

FindMe: A method for providing an alarm service according to the distance.

Proximity: A method for exchanging battery information.

Time: A method for exchanging time information

The GATT may be used as a protocol by which to describe how the ATT is utilized at the time of composing services. For example, the GATT may be used to define how the ATT profiles are grouped together with services and to describe characteristics associated with the services.

Therefore, the GATT and the ATT describe device statuses and services, and how features are associated with each other and how they are used.

The controller stack includes a physical layer 390, a link layer 380, and a host controller interface 370.

The physical layer 390 (or a wireless transmission and reception module) sends and receives radio signals of 2.4 GHz, and uses GFSK modulation and frequency hopping utilizing 40 RF channels.

The link layer 380 sends or receives Bluetooth packets.

Furthermore, the link layer establishes a connection between devices after performing the advertising and scanning function using three advertising channels, and provides a function of exchanging a maximum of 42 bytes of data packets through 37 data channels.

The host controller interface (HCI) provides an interface between the host stack and the controller stack so that the host stack may provide commands and data to the controller stack and the controller stack may provide events and data to the host stack.

Hereinafter, the procedure of BLE is described briefly.

The BLE procedure includes a device filtering procedure, an advertising procedure, a scanning procedure, a discovering procedure, and a connecting procedure.

### Device Filtering Procedure

The device filtering procedure functions to reduce the number of devices which perform responses to requests, commands, or notification in the controller stack.

All of devices may not need to respond to received requests. Accordingly, the controller stack reduces the number of transmitted requests so that power consumption may be reduced in the BLE controller stack.

An advertising device or a scanning device may perform the device filtering procedure in order to restrict the number of devices which receive advertisement packets, scan requests, or connection requests.

In this case, the advertising device refers to a device which sends an advertisement event, that is, a device which performs advertisement, and is also called an advertiser.

A scanning device refers to a device which performs scanning, that is, a device which sends a scan request.

In the BLE disclosure, if a scanning device receives part of advertisement packets from an advertising device, the scanning device has to send a scan request to the advertising device.

If the transmission of a scan request is not required as the device filtering procedure is used, however, the scanning device may ignore advertisement packets transmitted by an advertising device.

The device filtering procedure may be used even in the connection request procedure. If device filtering is used for the connection request procedure, the need for sending a response to a connection request may be made unnecessary by ignoring the connection request.

### Advertising Procedure

An advertising device performs an advertisement procedure to perform non-directional broadcast using the devices within the range of the advertising device.

In this case, the non-directional broadcast refers to broadcast in all directions rather than broadcast in specific directions.

Unlike the non-directional broadcast, the directional broadcast refers to broadcast in a specific direction. Non-directional broadcast is performed without involving a connection procedure between devices in a listening state (hereinafter referred to as a “listening device”).

The advertising procedure is used to establish a BLE to a nearby initiating device.

In some embodiments, the advertising procedure may be used to provide the periodic broadcast of user data to scanning devices which perform listening through an advertising channel.

In the advertising procedure, all of advertisements (or advertisement events) are broadcasted through an advertising physical channel.

An advertising device may receive a scan request from a listening device which performs a listening operation in order to obtain additional user data from the advertising device. In response to the scan request, the advertising device sends a response to the listening device which has sent the scan request through the same advertising physical channel through which the advertising device has received the scan request.

While broadcast user data sent as part of advertising packets forms dynamic data, scan response data is static for the most part.

An advertising device may receive a connection request from an initiating device through an advertising (or broadcast) physical channel. If the advertising device has used a connectable advertisement event and the initiating device has not been filtered by a filtering procedure, the advertising device stops an advertisement and enters connected mode. The advertising device may resume the advertisement after entering the connected mode.

### Scanning Procedure

A device performing a scan operation, i.e., a scanning device, performs a scanning procedure in order to listen to the non-directional broadcast of user data from advertising devices which use an advertising physical channel.

In order to request additional user data, a scanning device sends a scan request to an advertising device through an advertising physical channel. In response to the scan request, the advertising device includes additional user data requested by the scanning device in a scan response and sends the scan response to the scanning device through the advertising physical channel.

The scanning procedure may be used while a scanning device is connected to another BLE device in a BLE piconet.

If a scanning device receives a broadcast advertising event and stays in initiator mode where a connection request may be initiated, the scanning device may initiate BLE for an advertising device by sending a connection request to the advertising device through an advertising physical channel.

If a scanning device sends a connection request to an advertising device, the scanning device stops the entire scanning for additional broadcast and enters connected mode.

### Discovering Procedure

Devices capable of Bluetooth communication (hereinafter referred to as “Bluetooth devices”) perform an advertising procedure and a scanning procedure in order to discover devices around the Bluetooth devices or devices to be discovered by other devices within a given area.

The discovering procedure is performed in an asymmetric manner. A Bluetooth device searching for another Bluetooth device nearby is called a discovering device, and performs listening in order to search for devices that advertise advertisement events that may be scanned. A Bluetooth device which may be discovered and used by another device is called a discoverable device. A discoverable device actively broadcasts an advertisement event so that other devices may scan the discoverable device through an advertising (or broadcast) physical channel.

Both the discovering device and the discoverable device may already have been connected to other Bluetooth devices in a piconet.

### Connecting Procedure

A connecting procedure is asymmetric. In the connecting procedure, while a particular Bluetooth device performs an advertising procedure, other Bluetooth devices need to perform a scanning procedure.

In other words, the advertising procedure may be a primary task to be performed, and as a result, only one device may respond to an advertisement. After receiving a connectable advertisement event from an advertising device, the connecting procedure may be initiated by sending a connection request to the advertising device through an advertising (or broadcast) physical channel.

Operation statuses defined in the BLE technology, that is, an advertising state, a scanning state, an initiating state, and a connection state, are described briefly below.

### Advertising State

The link layer (LL) enters the advertising state in a command from a host (or stack). If the link layer is in the advertising state, the link layer sends advertising packet data units (PDUs) at advertisement events.

Each advertisement event includes at least one advertising PDU, and the advertising PDU is transmitted through an advertising channel index. Each advertisement event may be previously closed if the advertising PDU is transmitted through each advertising channel index, the advertising PDU is terminated, or the advertising device needs to secure the space in order to perform other functions.

### Scanning State

The link layer enters the scanning state in response to a command from a host (or stack). In the scanning state, the link layer listens to advertising channel indices.

The scanning state supports two types: passive and active scanning. The host determines a scanning type.

No separate time or advertising channel index is defined to perform scanning.

In the scanning state, the link layer listens to an advertising channel index for “scanWindow” duration. scanInterval is defined as the interval between the start points of two consecutive scan windows.

If there is no scheduling collision, the link layer has to perform listening in order to complete all of the scanIntervals of scanWindows as commanded by the host. In each scanWindow, the link layer has to scan other advertising channel indices. The link layer uses all of available advertising channel indices.

In the case of passive scanning, the link layer is unable to send any packet, but only receives packets.

In the case of active scanning, the link layer performs listening to the advertising device to rely on the advertising PDU type by which additional information related to the advertising PDUs and advertising device may be requested.

### Initiating State

The link layer enters the initiating state in response to a command from a host (or stack).

In the initiating state, the link layer performs listening to advertising channel indices.

In the initiating state, the link layer listens to an advertising channel index for “scanWindow” duration.

### Connection State

The link layer enters a connection state when the device performing the connection request, i.e., the initiating device transmits CONNECT_REQ PDU to the advertising device or when the advertising device receives CONNECT_REQ PDU from the initiating device.

After entering the connections state, it is considered that the connection is created. However, it need not be considered so that the connection is established at the time of entering the connections state. An only difference between a newly created connection and the previously established connection is a link layer connection supervision timeout value.

When two devices are connected to each other, two devices play difference roles.

A link layer serving as a master is referred to as the master and a link layer serving as a slave is referred to as the slave. The master controls a timing of a connection event and the connection event refers to a time at which the master and the slave are synchronized.

A packet defined in the Bluetooth interface will be briefly described below. BLE devices use packets defined below.

### Packet Format

The link layer has only one packet format used for both an advertising channel packet and a data channel packet.

Each packet is constituted by four fields, i.e., a preamble, an access address, a PDU, and a CRC.

When one packet is transmitted in an advertising physical channel, the PDU will become an advertising channel PDU and when one packet is transmitted in a data physical channel, the PDU will become a data channel PDU.

### Advertising Channel PDU

The advertising channel PDU includes a 16 bit header and a payload of various sizes.

The PDU type field of an advertising channel included in the header supports PDU types defined in Table 1 below.

TABLE 1

| | | | Permitted PHYS | | |
|---|---|---|---|---|---|
| PDU | | | LE | LE | LE |
| Type | PDU Name | Channel | IM | 2M | Coded |
| 0000b | ADV_IND | Primary | O | | |
| | | Advertising | | | |
| 0001b | ADV_DIRECT_IND | Primary | O | | |
| | | Advertising | | | |
| 0010b | ADV_NONCONN_IND | Primary | O | | |
| | | Advertising | | | |
| 0011b | SCAN_REQ | Primary | O | | |
| | | Advertising | | | |
| | AUX_SCAN_REQ | Secondary | O | O | O |
| | | Advertising | | | |
| 0100b | SCAN_RSP | Primary | O | | |
| | | Advertising | | | |
| 0101b | CONNECT_IND | Primary | O | | |
| | | Advertising | | | |
| | AUX_CONNECT_REQ | Secondary | O | O | O |
| | | Advertising | | | |
| 0110b | ADV_SCAN_IND | Primary | O | | |
| | | Advertising | | | |

### Advertising PDU

The following advertising channel PDU types are called advertising PDUs and are used for specific events.

ADV_IND: a connectable non-directional advertisement event

ADV_DIREC_IND: a connectable directional advertisement event

ADV_NONCONN_IND: a non-connectable non-directional advertisement event

ADV_SCAN_IND: a non-directional advertisement event that may be scanned

The PDUs are transmitted by the link layer in the advertising state and are received by the link layer in the scanning state or initiating state.

### Scanning PDUs

The advertising channel PDU type below is called a scanning PDU and is used in the status described below.

SCAN_REQ: transmitted by the link layer in the scanning state and received by the link layer in the advertising state.

SCAN_RSP: transmitted by the link layer in the advertising state and received by the link layer in the scanning state.

### Initiating PDUs

The advertising channel PDU type below is called an initiating PDU.

CONNECT_REQ: transmitted by the link layer in the initiating state and received by the link layer in the advertising state.

### Data Channel PDU

The data channel PDU may have a 16-bit header and various sizes of payloads and include a message integrity check (MIC) field.

The procedure, the state, the packet format, and the like in the BLE technology, which are described above, may be applied in order to perform methods proposed by the present disclosure.

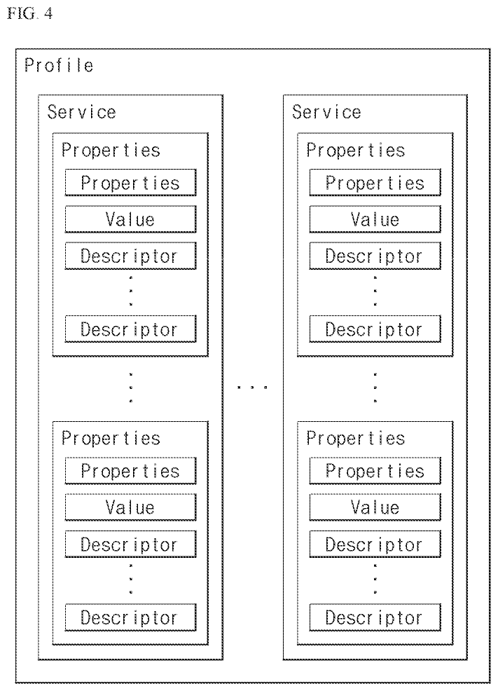

FIG. 4 illustrates an example of a structure of a generic attribute profile (GATT) of Bluetooth low energy.

Referring to FIG. 4, a structure for exchanging profile data of the Bluetooth low energy may be described.

Specifically, the generic attribute profile (GATT) is a definition of a method in which data is transmitted and received by using services and characteristics between the Bluetooth LE devices.

In general, a Peripheral device (e.g., a sensor device) serves as a GATT server and has a definition of services and characteristics.

A GATT client sends a data request to the GATT server in order to read or write the data and all transactions start at the GATT client and the response is received from the GATT server.

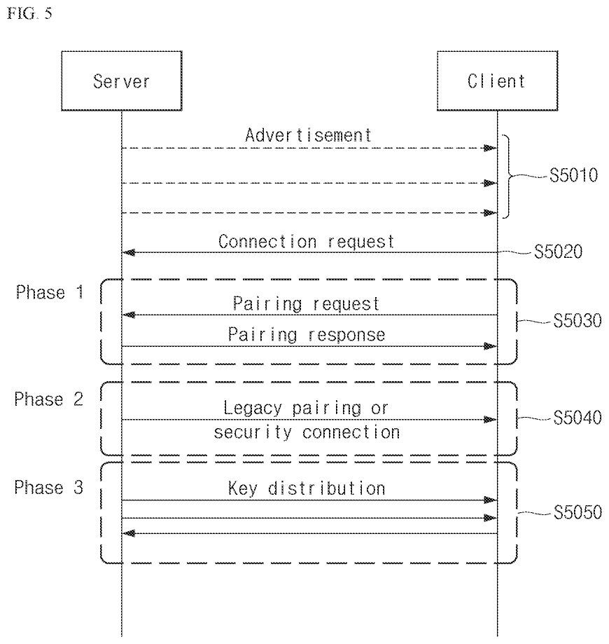

A GATT-based operation structure used in the Bluetooth LE may be based on THE profile, the service, and the characteristic, and may have a vertical structure illustrated in FIG. 5.

The profile may be constituted by one or more services and the service may be constituted by one or more characteristics or other services.

The service may serve to divide data into logical units and include one or more characteristics or other services. Each service has a 16-bit or 128-bit separator called a Universal Unique Identifier (UUID).

The characteristic is a lowest unit in the GATT-based operation structure. The characteristic includes only one datum and has a 16-bit or 128-bit UUID similar to the service.

The characteristic is defined as a value of various information and requires one attribute to contain each information. The characteristic may adopt various consecutive attributes.

The attribute is constituted by four components, which have the following meanings.
handle: Address of attribute
Type: Type of attribute
Value: Value of attribute
Permission: Access authority to attribute

FIG. 5 is a flowchart illustrating an example of a connection procedure method in Bluetooth low power energy technology to which the present disclosure may be applied.

A server transmits to a client an advertisement message through three advertising channels (S5010).

The server may be called an advertiser before connection and called as a master after the connection. As an example of the server, there may be a sensor (temperature sensor, etc.).

Further, the server may be called a scanner before the connection and called as a slave after the connection. As an example of the client, there may be a smartphone, etc.

As described above, in Bluetooth, communication is performed over a total of 40 channels through the 2.4 GHz band. Three channels among 40 channels as the advertising channels are used for exchanging sent and received for establishing the connection, which include various advertising packets.

The remaining 37 channels are used for data exchange after connection to the data channel.

The client may receive the advertisement message and thereafter, transmit the Scan Request message to the server in order to obtain additional data (e.g., a server device name, etc.).

In this case, the server transmits the Scan Response message including the additional data to the client in response to the Scan Request message.

Here, the Scan Request message and the Scan Response message are one type of advertising packet and the advertising packet may include only user data of 31 bytes or less.

Therefore, when there is data in which the size of the data is larger than 3 bytes, but overhead to transmit the data through the connection, the data is divided and sent twice by using the Scan Request message and the Scan Response message.

Next, the client transmits to the server a Connection Request message for establishing a Bluetooth connection with the server (S5020).

Therefore, a Link Layer (LL) connection is established between the server and the client.

Thereafter, the server and the client perform a security establishment procedure.

The security establishment procedure may be interpreted as security simple pairing or may be performed including the same.

That is, the security establishment procedure may be performed through Phase 1 through Phase 3.

Specifically, a pairing procedure (Phase 1) is performed between the server and the client (S5030).

In the pairing procedure, the client transmits a Pairing Request message to the server and the server transmits a Pairing Response message to the client.

Through the pairing procedure, authentication requirements and input (I)/output (O) capabilities and Key Size information are sent and received between the devices. Through the information, which key generation method is to be used in Phase 2 is determined.

Next, as Phase 2, legacy pairing or secure connections are performed between the server and the client (S5040).

In Phase 2, A 128-bit temporary key and a 128-bit short term key (STK) for performing the legacy pairing are generated.
Temporary Key: Key made for creating the STK
Short Term Key (LTK): Key value used for making encrypted connection between devices

When the secure connection is performed in Phase 2, a 128-bit long term key (LTK) is generated.
Long Term Key (LTK): Key value used even in later connection in addition to encrypted connection between the devices

Next, as Phase 3, a Key Distribution procedure is performed between the server and the client (S5050).

Therefore, the secure connection may be established and the data may be transmitted and received by establishing the encrypted link.

### General Matters Related to Isochronous Channel

With respect to an audio signal, audio streaming data or audio data may be periodically generated at an idle event interval.

The audio data is generated periodically (or at a specific time interval) according to a feature thereof. Here, the specific time interval at which the audio data is periodically generated may be expressed as idle event interval. Each audio data is transmitted at each idle event interval. Further, each audio data may be transmitted through an entire interval or a partial interval of the idle event interval. When the audio streaming data which is generated periodically or regularly is transmitted by using a BLE mechanism, an advertising and scanning procedure, a communication procedure, and a disconnection procedure should be performed whenever the generated audio data is transmitted/received. However, the audio data is generally periodically generated, and latency guarantee for audio data transmission is required regardless of a data mount of the audio data.

However, when the advertising and scanning procedure, the communication procedure, and the disconnection procedure should be performed each time newly generated audio data is transmitted, there is a problem in that latency occurs in audio data transmission.

In audio data transmission through hearing aids (HA) or headset, a data generation amount is comparatively small, so when BLE technology is utilized, higher energy efficiency may be obtained than Bluetooth BR/EDR technology, but since a data channel process of the BLE technology should perform advertising, connection, etc., every data transmission as described above, the data transmission has large overhead, and in particular, latency guarantee absolutely required for the audio data transmission may not be guaranteed.

Further, since the data channel process of the BLE technology has a purpose of transmitting isolatedly generated data only as necessary, and inducing deep sleep of a BLE device in other time domains to increase energy efficiency, it may be difficult to apply the data channel process of the BLE technology to transmission of periodically generated audio data.

### Definition of Isochronous Channel and Mechanism Related Thereto

A new channel, i.e., an isochronous channel is defined in order to transmit the periodically generated data by using the BLE technology.

The isochronous channel is a channel used for transmitting the isochronous data between devices (e.g., conductor-member) using an isochronous stream.

The isochronous data refers to data transmitted at a specific time interval, i.e., periodically or regularly.

That is, the isochronous channel may represent a channel in which periodically generated data such as audio data or voice data is transmitted and received in the BLE technology. Further, the isochronous channel may represent a channel on which data generated based on a user input of a game user's controller device is transmitted and received in a gaming scenario. The isochronous channel can be used for transmitting and receiving to data to and from a single member, a set of one or more coordinated members, or multiple members. Further, the isochronous channel corresponds to a flushing channel which can be used for transmitting and receiving key data in an isochronous stream such as an audio streaming or other time domains.

### CONFIGURATION OF VARIOUS EMBODIMENTS OF PRESENT DISCLOSURE

### Problems of Prior Art

1. When a user plays a game, a game controller (peripheral device or slave device) is connected to a game console (central device, host device, or master device) to enjoy the game, and in this case, an input delay occurs depending on a connection scheme between the game controller and the game console. Further, an audio output delay occurs depending on a connection scheme between a headset and the game console.

2. In the case of wired controllers and wired headsets, delay and jitter due to the connection scheme are nearly 0 ms, and most delays are merely delays due to software (SW) processing.

3. In the case of the wireless controllers and the wireless headsets, delays occur due to a wireless connection scheme, resulting in a time delay and the jitter.

4. Wireless controllers using a Bluetooth BR/EDR standard scheme experience delays and jitter due to a 12.5 ms polling scheme which is a standard recommended specification. Further, audio using a BR/EDR standard scheme using SBC codec experiences a time delay of approximately 150 to 200 ms due to the use of an input/output buffer caused by a network delay.

5. Moreover, when multiple users are connected, variation ranges of the delay and the jitter become greater due to an asynchronous wireless connection scheme.

### Improvements of Proposed Technology

1. An LE isochronous channel, standardized in 2020, was designed for audio transmission with guaranteed isochronous data transmission.

2. The LE isochronous channel may send data in a sub-event that is a much smaller unit than a BR/EDR basic time unit slot (625 μs), and since isochronism is guaranteed, unlike the BR/EDR scheme, polling by a master is not required.

3. The present disclosure is a proposal for how to load controller data traffic, which does not currently exist, over an LE Isochronous channel, and is a technology that guarantees connections of multiple users with a delay within 1 ms and without jitter variation.

4. Proposed is a technology that guarantees a QoS of audio data while simultaneously guaranteeing controller data.

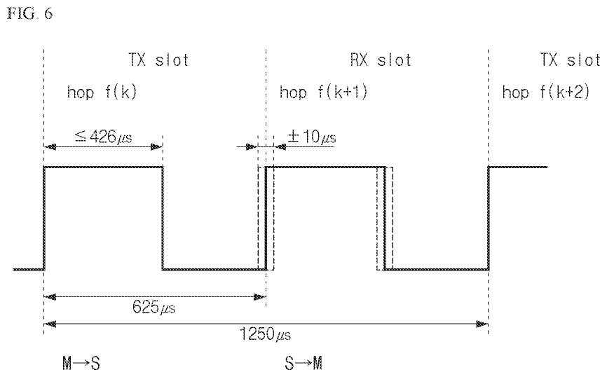

FIG. 6 illustrates an example of a process in which a central (host device or master device) and a peripheral device (slave device) sends and receives a signal to and from each other in a time domain.

BR/EDR timing: Transmission slot is fixed at 625 μs, transmission is made by a TDM scheme and with 1, 3, and 5 slot sizes, and Tx is transmitted at even slots, and Rx is transmitted at odd slots.

The central device (host device or master device) and the peripheral device (slave device) send and receive a signal to and from each other in a time domain which is constituted by sub-intervals of 625 microseconds.

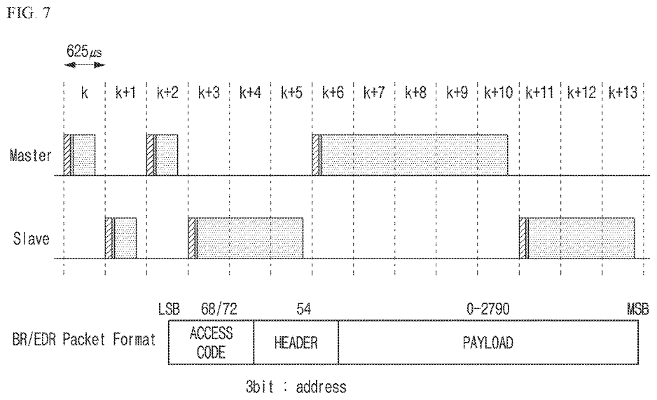

FIG. 7 illustrates an example of a process in which a central (host device or master device) and a peripheral device (slave device) sends and receives a signal to and from each other in a time domain.

The central device (host device or master device) and the peripheral device (slave device) send and receive a signal to and from each other in a time domain which is constituted by sub-intervals of 625 microseconds.

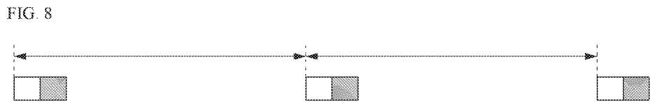

FIG. 8 illustrates an example of a configuration of a signal transmitted between the central device (host device or master device) and the peripheral device (slave device) in the time domain.

<Core vol2, partB, 4.3 Synchronous Logical Transport>

: SCO uses [symbol] HV1(⅓ FEC), HV2(⅔ FEC), and HV3(No FEC) packets. The SCO logical transport, is a symmetric, point-to-point transport between the master and a specific slave. The SCO logical transport reserves slots~

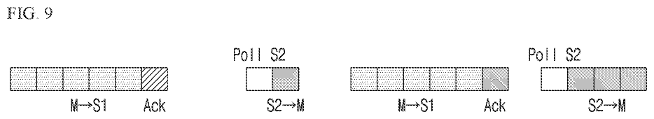

FIG. 9 illustrates an example of a configuration of a signal transmitted between the central device (host device or master device) and the peripheral device (slave device) in the time domain.

<Core vol2, partB, 4.4 Asynchronous Logical Transport>

In the slots not reserved for synchronous logical transports, the master may exchange packets with any slave on a per-slot basis. The ACL logical transport provides a packet-switched connection between the master and all active slaves participating in the piconet. Both asynchronous and isochronous services are supported. Only a single ACL logical transport shall exist between any two devices. For most ACL packets, packet retransmission is applied to assure data integrity.

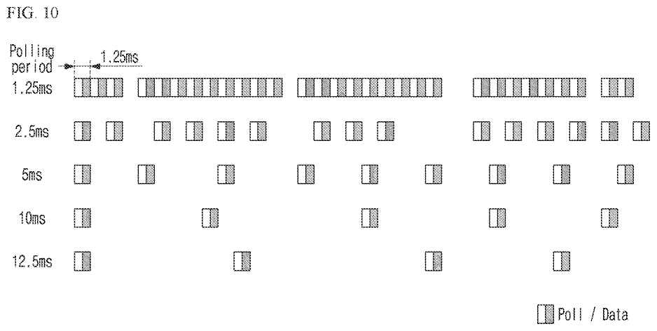

FIG. 10 illustrates an example of a configuration of a signal transmitted between the central device (host device or master device) and the peripheral device (slave device) in the time domain.

### Prior Art

Since BR/EDR game controller data transmission uses an asynchronous channel, the BR/EDR game controller data transmission may not guarantee that the controller will transmit data according to a polling period determined by a host.

In an example of FIG. 10, since a minimum slot length of BR/EDR is 625 μs, a minimum combined length of poll and data is 625×2=1.25 ms. When poll and data are sent at a minimum period of 1.25 ms, data may be transmitted 800 times per second. However, since the transmission scheme is the asynchronous scheme, even if the host fixes the transmission period, the controller transmits data in a best effort scheme, resulting in transmission that is not at a regular time interval in an air interface. As illustrated in a figure below, empty spaces occur intermittently, causing jitter variation.

In FIG. 10, 1.25 ms is a minimum period length, and to use other traffic, the period is extended to 2.5 ms, 5 ms, 10 ms, 12.5 ms, etc. However, as described above, even if the host determines the period, when the controller actually transmits data packets, the data packets are transmitted in the asynchronous scheme which is a best effort. The 2.5 ms period is a scheme of sending one poll and data, then pausing for one interval before sending again. The 5 ms period is a scheme of sending one poll and data, then pausing for three intervals before sending again. A BR/EDR standard Human Interface Device (HID) specification recommends a 12.5 ms transmission period, which is 10% of a total bandwidth (BW).

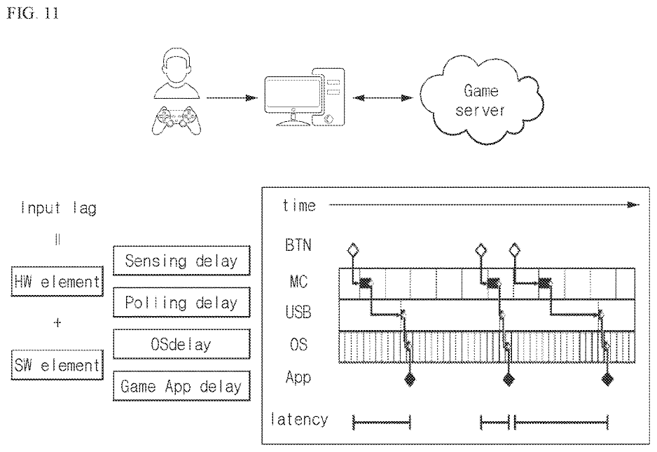

FIG. 11 illustrates an example of a configuration of the signal transmitted between the central device (host device or master device) and the peripheral device (slave device).

### Prior Art

The game controller is connected to a PC or game console either by wire or wirelessly. The wired connection uses a USB scheme, and follows a poll/data transmission scheme according to a USB HID specification. A polling period of a wired USB scheme is enabled to be set to a minimum of 1 ms and up to 2 ms, 5 ms, 10 ms, etc. The wireless connection uses a Bluetooth scheme, and follows a poll/data transmission scheme according to a Bluetooth HID specification. The polling period of the wireless Bluetooth scheme is enabled to be set to a minimum of 1.25 ms and up to 2.5 ms, 5 ms, 10 ms, 12.5 ms, etc.

An input lag of the controller depends on hardware factors including a sensing delay (a time for a microcontroller to recognize a button input value) and a polling delay (a time for transmission from the controller to the PC or game console via USB or Bluetooth), and software factors including OS delay (the time for the PC or game console OS to read a controller receive buffer value) and a game application delay (a time for game software to read OS data).

In the case of the wireless Bluetooth scheme, the polling delay has a greatest impact on the input lag.

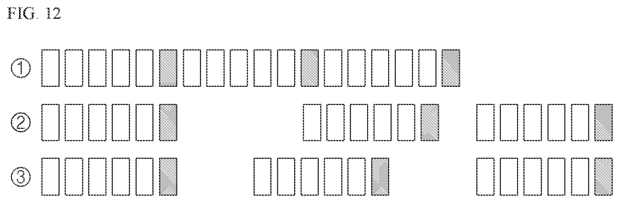

FIG. 12 illustrates an example of a configuration of the signal transmitted between the central device (host device or master device) and the peripheral device (slave device).

### Prior Art

Audio transmission at 340 kbps (SBC joint stereo) occupies 30% of total BW @ 1 Mbps and 15% @ 2 Mbps.

Problems of the prior art are as follows:

1. There is no criterion for determining which length (100 ms, 500 ms, or 1 sec) of a total BW interval for buffer management.

2. Audio uses DH5 of an asynchronous channel (sending 5 consecutively, then Ack), but the host may not predict how DH5 placement will be made in an actual air interface (fixed to DH5 in a chipmaker providing code as maximum channel efficiency is provided). The controller receives commands from the host and sends packets asynchronously based on a channel condition and a buffer status.

As illustrated in \textcircled{1} of FIG. 12, all may be transmitted consecutively.

As illustrated in \textcircled{2} of FIG. 12, all may be transmitted at an irregular interval according to a buffer margin, or

As illustrated in \textcircled{3} of FIG. 12, all may be transmitted at a regular interval (similar to LE isochronous).

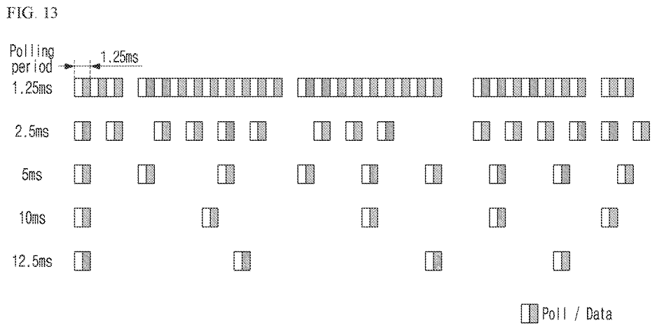

FIG. 13 illustrates an example of a configuration of the signal transmitted between the central device (host device or master device) and the peripheral device (slave device).

### Prior Art

Since BR/EDR uses the asynchronous channel, the BR/EDR may not guarantee that the controller will transmit data/poll according to a polling period set by the host.

In FIG. 13, a transmission mode is described in which in order to retrieve data of a slave device from a master, when the master transmits a poll (white) to the slave, the slave returns data (gray).

To accommodate DH5 which is an audio packet in a Piconet managed by one master, a joystick polling period must be 5 ms or more: 625 us*2 (Joystick)+625 us*6 (Audio)=5 ms

FIG. 13 illustrates a transmission mode in which one master has two slaves (controller and headset). Since the audio packet also uses the asynchronous channel, it is impossible to predict how the audio packets will be combined, which necessitates a large buffer length and consequently results in a long time delay.

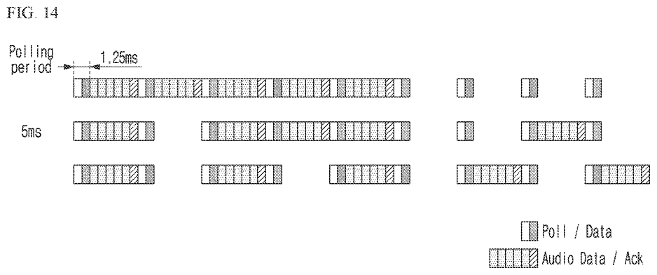

FIG. 14 illustrates an example of a configuration of the signal transmitted between the central device (host device or master device) and the peripheral device (slave device).

When an SBC 1-channel which is the BR/EDR standard codec is sampled at 4096 bytes (generally sampled in size units of 4096 bytes) and compressed by ¼, an audio packet size becomes 1024 bytes.

Since a maximum size of DH5 is 226 bytes, 5 DH5 packets are required for transmission per channel (226×5=1130>1024).

A2DP, which is an audio transmission profile standard, transmits left and right 2 channels as one joint stereo and provides 20 to 30% coding gain compared to an L/R stereo. To transmit one UR stereo sample, approximately 8 DH5 packets are required, and since a transmission array of 8 DH5 packets is unpredictable as described above, a large buffer length must be allocated.

For reference, AVDTP, which is an audio transmission protocol standard, uses RTP and employs an FEC mechanism to guarantee a QoS of packet transmission.

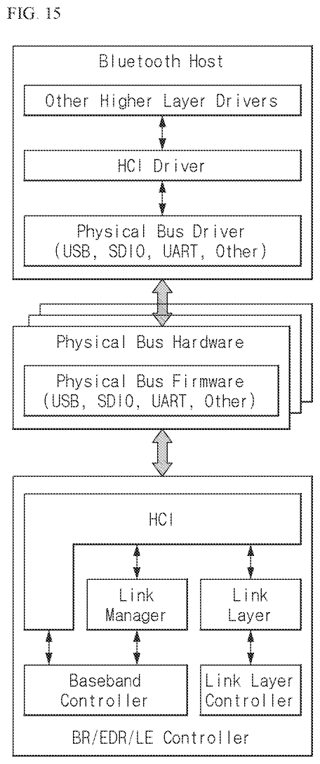

FIG. 15 illustrates an example of a configuration of the signal transmitted between the central device (host device or master device) and the peripheral device (slave device).

An HCI Interface is a specification (Host Controller Interface) for communication between different heterogeneous companies between the host and the controller.

Both the central device and the peripheral device have HCI interfaces, which constitute a logical interface between an upper host and a lower controller.

The HCI provides a uniform command method for the Host to access Controller capabilities and to control connections to other Controllers. For the BR/EDR or LE Controller, these commands typically involve the Link Manager (LM) to exchange LMP commands or the Link Layer (LL) to exchange LL Control packets with remote Bluetooth devices.

The HCI driver on the Host exchanges data and commands with the HCI firmware on the Bluetooth hardware. The Host Control Transport Layer (i.e. physical bus) driver provides both HCI layers with the ability to exchange information with each other.

The Host will receive asynchronous notifications of HCI events independent of which Host Controller Transport Layer is used. HCI events are used for notifying the Host when something occurs. When the Host discovers that an event has occurred it will then parse the received event packet to determine which event occurred.

The Host Controller Interface driver (which interfaces to the Controller) should be independent of the underlying transport technology. In addition, the transport should not require any understanding of the data that the Host Controller Interface driver passes to the Controller.

The HCI provides a unified command method that allows the host to access a controller function and control connections to other controllers. For the BR/EDR or LE controller, the command generally includes a link manager (LM) that exchanges an LMP command or a link layer (LL) that exchanges an LL control packet with a remote Bluetooth device.

An HCI driver of the host exchanges data and commands with HCI firmware of Bluetooth hardware. A host control transmission layer (e.g., physical bus) driver provides a function for two HCI layers to exchange information with each other.

The host receives an asynchronous notification of an HCI event regardless of which host controller transmission layer being used. The HCI event is used for notifying the host when something occurs. When the host discovers that an event occurs, the host confirms which event occurs by performing a syntax analysis a received event packet.

A host controller interface driver (controller and interface) must be independent of a basic transmission technology. Further, a host controller interface driver does not need to understand data forwarded to the controller during transmission.

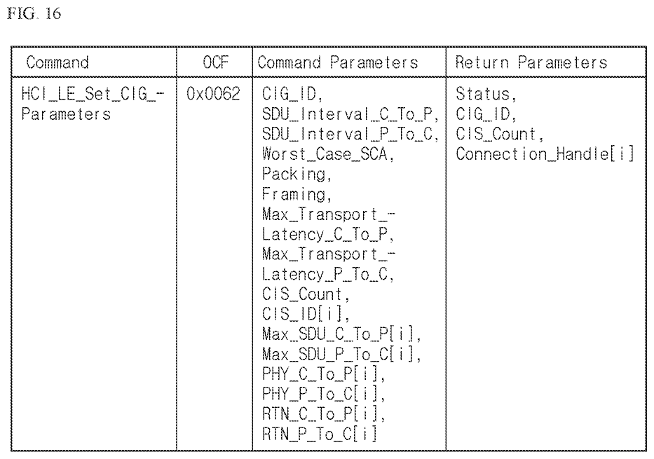

FIG. 16 illustrates an example of a configuration of the signal transmitted between the central device (host device or master device) and the peripheral device (slave device).

In a BLE ISO standard specification, the host of the central downloads an HCI_LE_Set_CIG_Parameters command to the controller, and the controller selects a timing parameter of the link layer. There is no link layer timing parameter in a parameter used in an HCI command.

The link layer timing parameter of the controller is a parameter of an LL_CIS_REQ LL Control PDU described below.

When SDU_Interval, Max_SDU_size, and Max_Transport_Latency values which are host-level context parameters, the controller in the Link Layer determines link-level timing parameters such as ISO_Interval, Sub_Interval, BN, NSE, and FT.

When a standard specification related to Bluetooth Low Energy is followed as it-is, BN represents a Sub Event number indicating burst traffic, so 1>Sub Events responsible for PDU transmission in the Link layer are transmitted consecutively according to a BN count, and 2>depending on a controller's performance and an implementation method for determining the Sub Interval, a Sub Interval length will vary. In this case, when attempting to mix with equally-spaced ULL HID traffic, Audio Sub events always occupy a front portion of the ISO Interval, preventing ULL HID traffic allocation and forcing a ULL HID interval to be relatively long. When mixing Audio and ULL, following the standard as-it is results in timing conflicts between Audio packets and HID packets, thereby preventing proper mixing.

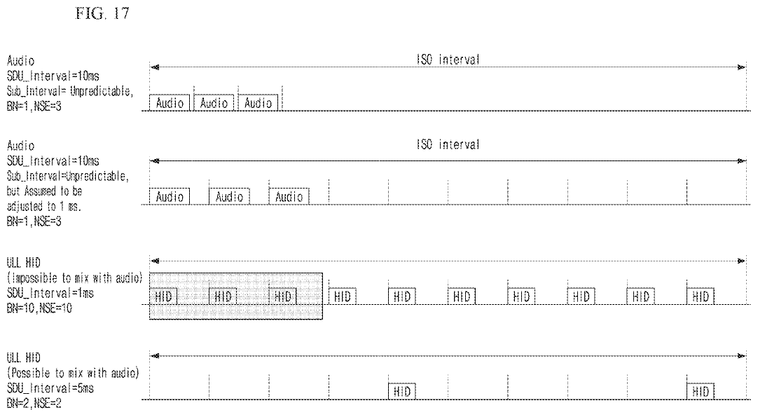

FIG. 17 illustrates an example of a configuration of the signal transmitted between the central device (host device or master device) and the peripheral device (slave device).

The first is Audio, and is based SDU_Interval=10 ms, Sub_Interval=unpredictable, BN=1, and NSE=3. Since the Sub_Interval is determined by the Controller, an exact length may not be known.

The second is Audio, and is assumed to be adjusted to Audio, SDU_Interval=10 ms, Sub_Interval=unpredictable, but 1 m, and is based on BN=1 and NSE=3.

The third is ULL HID (impossible to mix with Audio), and is based on SDU_Interval=1 ms, BN=10, and NSE=10. There is a problem in that a ULL HID signal overlaps with the first Audio or the second Audio in the time domain.

The fourth is ULL HID (possible to mix with Audio), and is based on SDU_Interval=5 ms, BN=2, and NSE=2. The ULL HID signal does not overlap with the first Audio or the second Audio in the time domain.

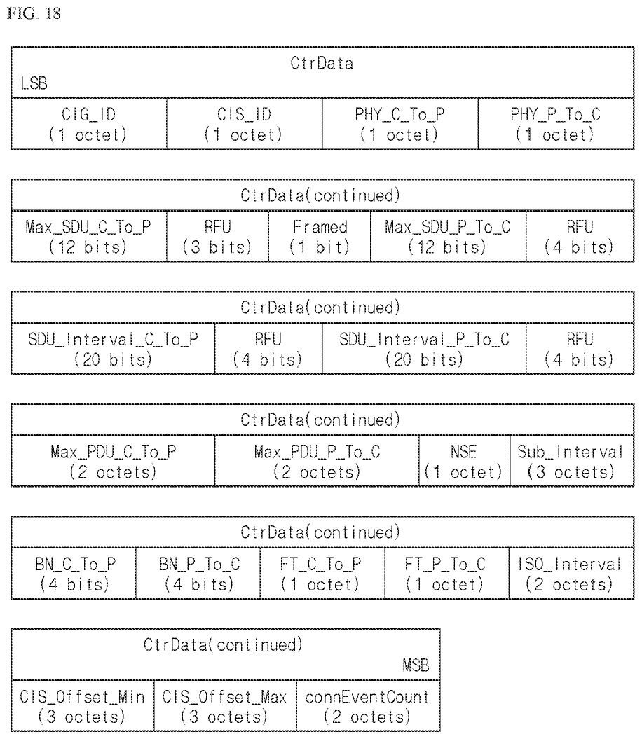

FIG. 18 illustrates an example of a configuration of the signal transmitted between the central device (host device or master device) and the peripheral device (slave device).

### Prior Art

The controller that receives an HCI command interprets an HCI parameter and creates an LL parameter to create a CIS.

ISO_Interval, Sub_Interval, BN, NSE, FT, Offset, and the like are configured.

A central link layer may use a connected isochronous stream generation procedure to generate a CIS between the central device and the peripheral device. The central link layer initiates this procedure by transmitting an LL_CIS_REQ PDU. A peripheral link layer does not initiate this procedure. The central link layer should generate the CIS only when requested by the host, and use only a CIS_ID for which the host has already stored configuration in this CIG and should not use a CIS_ID that corresponds to a conventional CIS of the CIG (see Section 4.5).

The central device shall not initiate this procedure when the connected isochronous stream (host support) feature bit is not configured in the controller. If the connected isochronous stream (host support) feature bit is not configured in the local link layer, and a remote link layer sends an LL_CIS_REQ PDU, the local link layer should send an LL_REJECT_EXT_IND PDU with an error code unsupported remote feature (0x1A).

When the link layer of the peripheral device receives the LL_CIS_REQ PDU, the link layer of the peripheral device needs to either immediately reject the proposed CIS or notify the host. In a latter case, the host requests the link layer to accept or reject the proposed CIS. The peripheral device should reject the proposed CIS when any PHY field in the LL_CIS_REQ PDU has no bit configured or 1 bit or more configured, or when a bit set corresponds to a PHY that is not supported by a receiver or is reserved for future use. When the peripheral device rejects the proposed CIS, the peripheral device should send an LL_REJECT_EXT_IND PDU with an appropriate reason code. When the peripheral device accepts the CIS, the peripheral device should send the LL_CIS_RSP PDU. When the central link layer receives the LL_CIS_RSP PDU, the central link layer should respond with the LL_CIS_IND PDU to generate the CIS or respond with the LL_REJECT_EXT_IND PDU with an appropriate reason code to cancel the CIS. The central device should not cancel the CIS when a proposed timing is within a time specified in the LL_CIS_REQ PDU, unless the host requests CIS termination.

The Central Link Layer may use the Connected Isochronous Stream Creation procedure to create a CIS between a Central and a Peripheral. The Central Link Layer initiates this procedure by sending an LL_CIS_REQ PDU. The Peripheral Link Layer shall not initiate this procedure. The Central's Link Layer shall only create a CIS when requested by the Host, only using a CIS_ID that the Host has already stored a configuration for in this CIG, and not using a CIS_ID that corresponds to an existing CIS in the CIG (see Section 4.5.14.3).

The Central shall not initiate this procedure if the Connected Isochronous Stream (Host Support) feature bit is not set in its Controller. If the remote Link Layer sends an LL_CIS_REQ PDU when the Connected Isochronous Stream (Host Support) feature bit is not set in the local Link Layer, the local Link Layer shall send an LL_REJECT_EXT_IND PDU with the error code Unsupported Remote Feature (0x1A).

When the Peripheral's Link Layer receives the LL_CIS_REQ PDU, it shall either reject the proposed CIS immediately or notify the Host. In the latter case, the Host requests the Link Layer to either accept or reject the proposed CIS. If either PHY field of the LL_CIS_REQ PDU has no bits or more than one bit set, or if the bit set corresponds to a PHY that the recipient does not support or is reserved for future use, the Peripheral shall reject the proposed CIS. If the Peripheral rejects the proposed CIS, it shall send an LL_REJECT_EXT_IND PDU with the appropriate reason code. If it accepts the CIS, it shall send an LL_CIS_RSP PDU. When the Central's Link Layer receives an LL_CIS_RSP PDU, it shall either create the CIS by replying with an LL_CIS_IND PDU or shall cancel it by replying with an LL_REJECT_EXT_IND PDU with the appropriate reason code. The Central shall not cancel the CIS if the proposed timings are within those specified in the LL_CIS_REQ PDU unless the Host requested that the CIS be terminated.

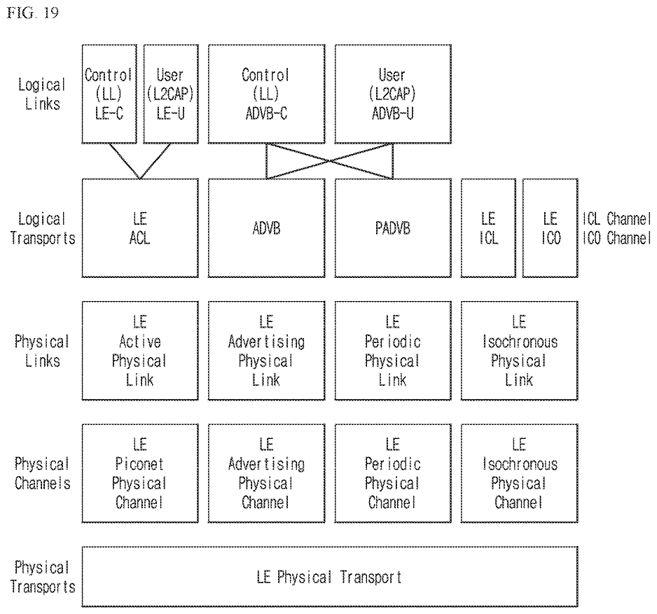

FIG. 19 illustrates an example of a stack of Bluetooth Low Energy (BLE).

FIG. 19 illustrates a stack presented in Bluetooth low energy technology v5.2.

Definitions of main terms are as follows.

### Connection-Related Definitions

Physical channel: Synchronized Bluetooth baseband compatible RF hopping sequence

Piconet: A set of Bluetooth devices that share a same physical channel defined by master parameters (clock and BD_ADDR)

Physical link: A baseband-level connection between two devices configured using paging. The physical link comprises a series of transmission slots of physical channels that are alternately constituted by master transmission slots and slave transmission slots.

An LE isochronous physical channel is characterized by a pseudo-random sequence of the PHY channel and three additional parameters provided by the master or a connectionless broadcaster. A first parameter is a channel map that represents a set of PHY channels. A second parameter is a pseudo-random number used as an index for an entire PHY channel set. A third parameter is a timing of a first data packet. A first packet timing of the CIS is provided in a link layer message transmitted in a related ACL connection by the master during a CIS configuration step. A first packet timing of the BIS may be referenced in periodic advertising events related to the BIS.

Physical channel: A Synchronized Bluetooth Baseband-compliant RF hopping sequence

Piconet: A set of Bluetooth devices sharing the same physical channel defined by the master parameters (clock and BD_ADDR)

Physical link: A Baseband-level connection between two devices established using paging. A physical link comprises a sequence of transmission slots on a physical channel alternating between master and slave transmission slots.

The LE isochronous physical channel is characterized by a pseudo-random sequence of PHY channels and by three additional parameters that are provided by a master or a connectionless broadcaster. The first parameter is the channel map that indicates the set of PHY channels. The second parameter is a pseudo random number that is used as an index into the complete set of PHY channels. The third parameter is the timing of the first data packet. The timing of the first packet of a CIS is provided in the Link Layer message that is sent in the associated ACL connection by the master during the CIS establishment phase. The timing of the first packet of a BIS is referenced from a periodic advertising event associated with the BIS.

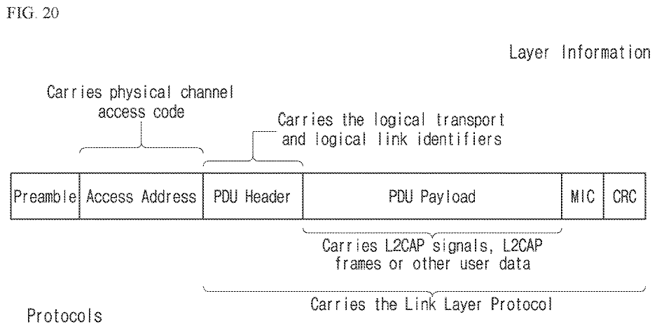

FIG. 20 illustrates an example of a configuration of the signal transmitted between the central device (host device or master device) and the peripheral device (slave device).

The signal is composed of a Preamble, Access Address, PDU Header. PDU Payload, MIC, and CRC.

The Access Address carries a physical channel access code.

The PDU Header carries the logical transport and logical link identifiers.

The PDU payload carries L2CAP signals, L2CAP frames, or other user data.

The PDU Header, PDU Payload, MIC, and CRC carry the Link Layer Protocol.

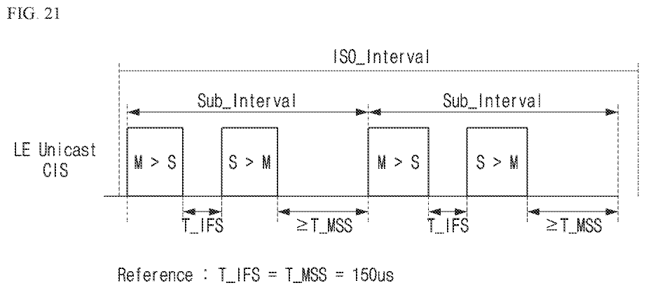

FIG. 21 illustrates an example of a configuration of a signal transmitted between the central device (host device or master device) and the peripheral device (slave device) in the time domain.

### Proposed Technology

The LE isochronous channel is a channel that guarantees isochronism and guarantees that the controller transmits according to the polling period set by the host.

The LE isochronous channel has a similar sub_interval to a BR/EDR slot. A sub_interval of a unicast channel is adjusted in units of 30 us from a minimum of 400 us.

A sub_interval of a broadcast channel is adjusted in units of 30 us from a minimum of 300 us.

An ISO_interval is configured to a length longer than the sub_interval for transmission buffer management, and when an ISO_interval time is reached, a transmission buffer is flushed (emptied) and new data is transmitted.

Unicast performs bidirectional communication between the master and the slave by using a Connected Isochronous Stream (CIS).

Broadcast performs unidirectional communication between the master and the slave by using a Broadcast Isochronous channel (BIS).

A CIS is a logical transport that enables connected devices to transfer isochronous data in either direction. The data may be fixed or variable size and may be framed or unframed. The isochronous data can be transferred either in an LE-S or LE-F logical link using the CIS logical transport. Each CIS shall be associated with an ACL.

A CIS supports variable size packets and transmission of one or more packets in each isochronous event, allowing a range of data rates to be supported.

Data traffic is unidirectional or bidirectional between the devices. There is an acknowledgment protocol to improve the reliability of packet delivery in a CIS.

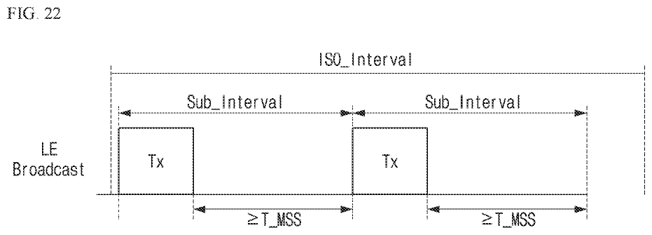

FIG. 22 illustrates an example of a configuration of a signal transmitted between the central device (host device or master device) and the peripheral device (slave device) in the time domain.

A BIS is a logical transport that enables a device to transfer isochronous data. The isochronous data can be either framed or unframed. The BIS supports variable size packets and the transmission of one or more packets in each isochronous event, allowing a range of data rates to be supported. The data traffic is unidirectional from the broadcasting device. Hence, there is no acknowledgment protocol and broadcast isochronous traffic is inherently unreliable. To improve the reliability of packet delivery, the BIS supports multiple retransmissions.

A BIS is a logical transport that enables a device to transfer isochronous data. The isochronous data can be either framed or unframed. A BIS supports variable size packets and the transmission of one or more packets in each isochronous event, allowing a range of data rates to be supported. The data traffic is unidirectional from the broadcasting device; hence there is no acknowledgment protocol and broadcast isochronous traffic is inherently unreliable. To improve the reliability of packet delivery, the BIS supports multiple retransmissions.

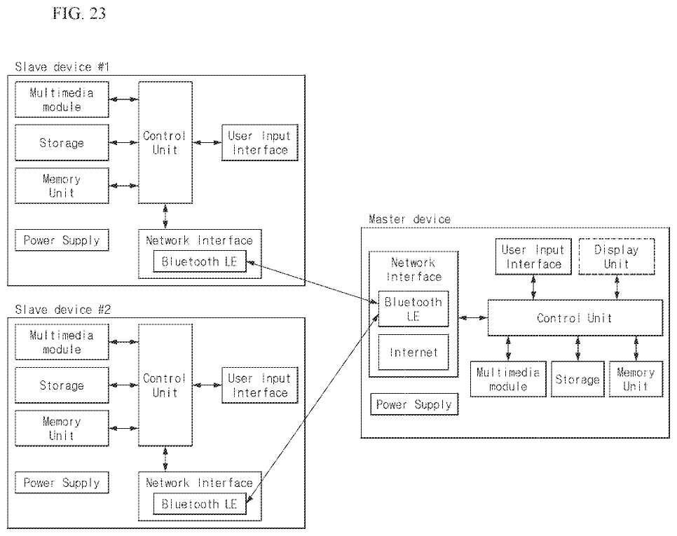

FIG. 23 illustrates an example of a configuration of the central device (host device or master device) and the peripheral device (slave device) in the time domain according to various embodiments of the present disclosure.

A central device (host device or master device) and a plurality of peripheral devices (slave devices) may be connected through a network interface based on Bluetooth Low Energy.

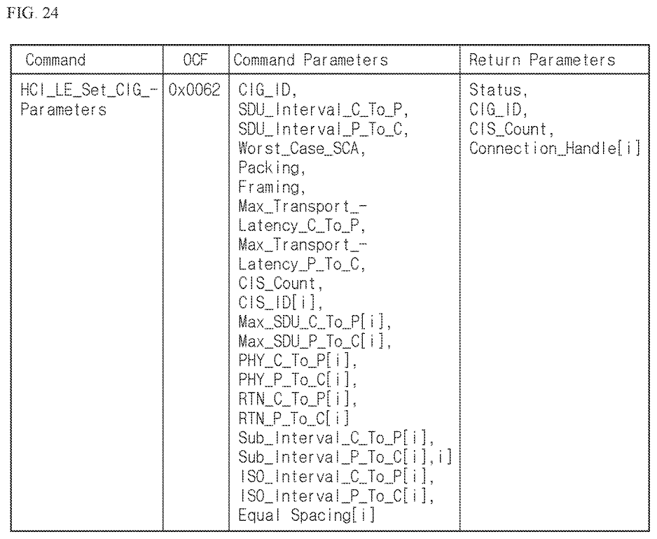

FIG. 24 illustrates an example of a configuration of a signal transmitted between the central device (host device or master device) and the peripheral device (slave device) according to various embodiments of the present disclosure.

When configuring the CIS channel for audio, the HCI command must also be extended to support a sub-event and an equal spacing, similar to ULL CIS.

A Sub-Interval Parameter is inserted into an HCI_LE_Set_CIG_Parameters command illustrated in FIG. 24 so as to specify the Sub interval for each CIS.

In order to enable the equal spacing to be configured within the ISO_Interval, when an ISO_Interval value as a parameter, the ISO_interval is configured to take a same value as the SDU_Interval, or the ISO_Interval value is arbitrarily configured by the controller, a flag is added to enable the equal spacing.

By extending the CIS channel configuration command for Audio as described above, conflicts may be prevented when mixing Audio and ULL HID data, and because conflicts are prevented, the QoS of both the Audio and the ULL HID may be guaranteed.

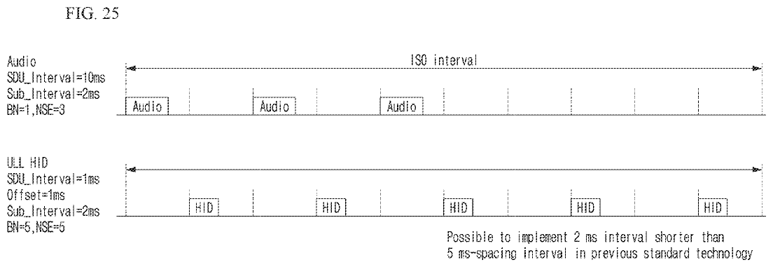

FIG. 25 illustrates an example of a configuration of the signal transmitted between the central device (host device or master device) and the peripheral device (slave device) in the time domain according to various embodiments of the present disclosure.

The Audio signal is transmitted based on SDU_Interval=10 ms, Sub_Interval=2 ms, BN=1, and NSE=3.

The ULL HID signal is transmitted based on SDU_Interval=1 ms, Offset=1 ms, Sub_Interval=2 ms, BN=5, and NSE=5.

According to the embodiment of FIG. 25, a minimum of 2 ms interval may be enabled to be implemented, which is shorter than a 5 ms interval according to the standard technology of FIG. 17.

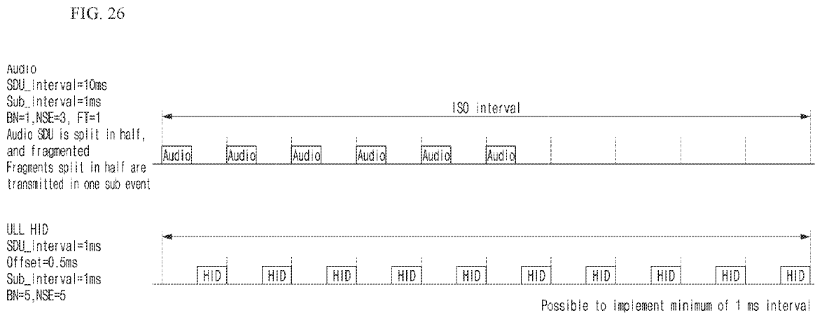

FIG. 26 illustrates an example of a configuration of the signal transmitted between the central device (host device or master device) and the peripheral device (slave device) in the time domain according to various embodiments of the present disclosure.

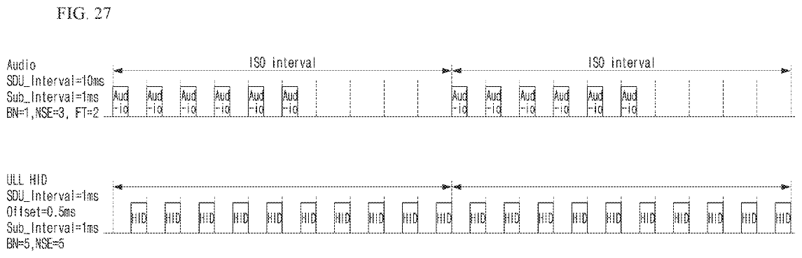

FIG. 27 illustrates an example of a configuration of the signal transmitted between the central device (host device or master device) and the peripheral device (slave device) in the time domain according to various embodiments of the present disclosure.

When audio data of 100 bytes (48 kHz sample) is reduced to 50 bytes and divided into two fragments, an audio fragment may be sent within 0.5 ms. When this sending is possible, HID data may be sent at a 1 ms interval, since the HID data is small data that is transmitted within 0.5 ms.

When sending the audio data as the audio fragment in the ISO interval, more space remains in a latter portion as illustrated in FIG. 26 or 27, so even if hardware performance is not optimal, the audio data is fragmented in a smaller size to reduce a hardware (HW) burden. Further, since the audio has a margin in decoding time (30 to 40 ms delay is acceptable), FT need not be configured to 1 but may be increased to 2 or 3, thereby providing sufficient space for fragmenting and inserting the audio.

According to the embodiment of FIG. 26 or 27, a minimum of 1 ms interval may be enabled to be implemented, which is shorter than the 5 ms interval according to the standard technology of FIG. 17.

### [Description Related to Central Device Claim]

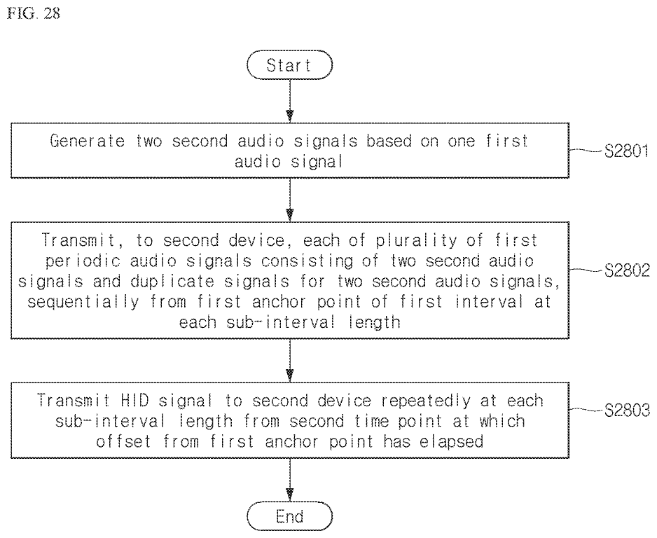

Hereinafter, the above-described embodiments will be described in detail with reference to FIG. 28 in terms of the operation of a UE Methods to be described below are just distinguished for convenience and unless the methods mutually exclusive, it is needless to say that some components of any one method may be substituted with some components of another method or may be applied in combination with each other.

FIG. 28 illustrates an example of an operation process of a wireless device in the short-range wireless communication system according to various embodiments of the present disclosure.

According to various embodiments of the present disclosure, a method performed by a wireless device (i.e., a first device) in a short-range wireless communication system is provided.

The first device includes: a first processor corresponding to a host stack; a second processor corresponding to a first controller stack; a memory; and a transceiver. The host stack and the controller stack are connected by a Host Controller Interface (HCI).

In step S2801, the first device generates two second audio signals based on one first audio signal.

In step S2802, the first device transmits, to a second device, each of a plurality of first periodic audio signals consisting of two second audio signals and duplicate signals for the two second audio signals, sequentially from a first anchor point of a first interval at each sub-interval length.

In step S2803, the first device transmits a human interface device (HID) signal to the second device repeatedly at each sub-interval length from a second time point at which an offset from the first anchor point has elapsed.

Each of the plurality of first periodic audio signals and the HID signal are not transmitted while being overlapped with each other.

According to various embodiments of the present disclosure, the offset may correspond to ½ of the sub-interval, and each of the plurality of first periodic audio signals may be transmitted for a time period shorter than the offset.

According to various embodiments of the present disclosure, the first audio signal may correspond to ½ or more of the sub-interval, and each of the second audio signals and the duplicate signals may correspond to less than ½ of the sub-interval.

According to various embodiments of the present disclosure, the first interval may be constituted by a plurality of first sub-intervals, each of the first sub-intervals may correspond to the sub-interval length, and the plurality of first periodic audio signals may be constituted by a smaller number than the plurality of first sub-intervals.

According to various embodiments of the present disclosure, the plurality of first periodic audio signals may be transmitted through first sub-intervals in an order corresponding to the number of plurality of first periodic audio signals, from a first sub-interval among the plurality of first sub-intervals. The plurality of first periodic audio signals may not be transmitted in a last first sub-interval from a next first sub-interval following the first sub-interval in an order corresponding to the number of plurality of first periodic audio signals among the plurality of first sub-intervals.

According to various embodiments of the present disclosure, the HID signal may be transmitted in all of the plurality of first sub-intervals.

According to various embodiments of the present disclosure, a second interval may follow the first interval, and the plurality of first periodic audio signals and the HID signal may be transmitted in the second interval similarly as in the first interval.

According to various embodiments of the present disclosure, a wireless device is provided in a short-range wireless communication system. The wireless device includes: a first processor corresponding to a host stack; a second processor corresponding to a first controller stack; a memory; and a transceiver. The host stack and the controller stack are connected by a Host Controller Interface (HCI). The memory may be configured to store instructions for performing the operation method of the first device according to FIG. 28 based on being executed by the first processor and the second processor.

According to various embodiments of the present disclosure, a control device controlling the wireless device is provided in the short-range wireless communication system. The control device includes at least one processor; and at one memory operably accessing the at least one processor. The at least one memory may be configured to store instructions for performing the operation method of the first device according to FIG. 28 based on being executed by the at least one processor.

According to various embodiments of the present disclosure, provided are one or more non-transitory computer readable media (CRM) storing one or more instructions. The one or more instructions may perform operations based on being executed by one or more processors, and the operations may include the operation method of the first device according to FIG. 28.

### [Description Related to Peripheral Device Claim]

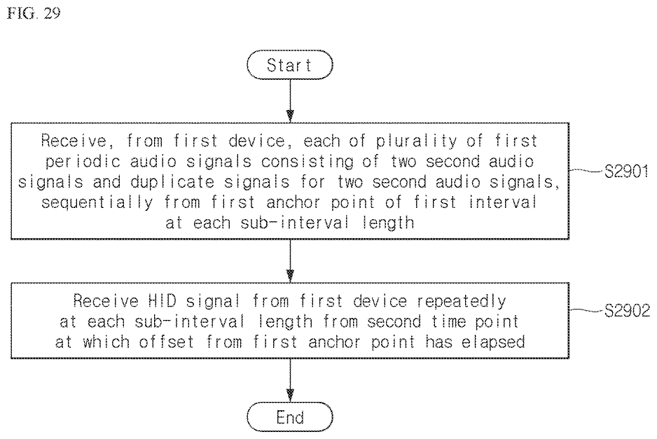

Hereinafter, the above-described embodiments will be described in detail with reference to FIG. 29 in terms of the operation of a UE. Methods to be described below are just distinguished for convenience and unless the methods mutually exclusive, it is needless to say that some components of any one method may be substituted with some components of another method or may be applied in combination with each other.

FIG. 29 illustrates an example of an operation process of a wireless device in the short-range wireless communication system according to various embodiments of the present disclosure.

According to various embodiments of the present disclosure, a method performed by a wireless device (i.e., a second device) in a short-range wireless communication system is provided.

The second device includes: a first processor corresponding to a host stack; a second processor corresponding to a second controller stack; a memory; and a transceiver. The host stack and the controller stack are connected by a Host Controller Interface (HCI).

In step S2901, the second device receives, from a first device, each of a plurality of first periodic audio signals consisting of two second audio signals and duplicate signals for the two second audio signals, sequentially from a first anchor point of a first interval at each sub-interval length. The second audio signals are based on one first audio signal.

In step S2902, the second device receives a human interface device (HID) signal from the first device repeatedly at each sub-interval length from a second time point at which an offset from the first anchor point has elapsed. Each of the plurality of first periodic audio signals and the HID signal are not transmitted while being overlapped with each other.

According to various embodiments of the present disclosure, the offset may correspond to ½ of the sub-interval, and each of the plurality of first periodic audio signals may be received for a time period shorter than the offset.

According to various embodiments of the present disclosure, the first audio signal may correspond to ½ or more of the sub-interval, and each of the second audio signals and the duplicate signals may correspond to less than ½ of the sub-interval.

According to various embodiments of the present disclosure, the first interval may be constituted by a plurality of first sub-intervals, each of the first sub-intervals may correspond to the sub-interval length, and the plurality of first periodic audio signals may be constituted by a smaller number than the plurality of first sub-intervals.

According to various embodiments of the present disclosure, the plurality of first periodic audio signals may be received through first sub-intervals in an order corresponding to the number of plurality of first periodic audio signals, from a first first sub-interval among the plurality of first sub-intervals. The plurality of first periodic audio signals may not be received in a last first sub-interval from a next first sub-interval following the first sub-interval in an order corresponding to the number of plurality of first periodic audio signals among the plurality of first sub-intervals.

According to various embodiments of the present disclosure, each of the plurality of PDUs may be transmitted from the second processor to the first processor within a sub interval after reception of each of the plurality of PDUs.

According to various embodiments of the present disclosure, the HID signal may be received in all of the plurality of first sub-intervals.

According to various embodiments of the present disclosure, a wireless device is provided in a short-range wireless communication system. The wireless device includes: a first processor corresponding to a host stack; a second processor corresponding to a second controller stack; a memory; and a transceiver. The host stack and the controller stack are connected by a Host Controller Interface (HCI). The memory may be configured to store instructions for performing the operation method of the second device according to FIG. 29 based on being executed by the first processor and the second processor.

According to various embodiments of the present disclosure, a control device controlling the wireless device is provided in the short-range wireless communication system. The control device includes at least one processor; and at one memory operably accessing the at least one processor. The at least one memory may be configured to store instructions for performing the operation method of the second device according to FIG. 29 based on being executed by the at least one processor.

According to various embodiments of the present disclosure, provided are one or more non-transitory computer readable media (CRM) storing one or more instructions. The one or more instructions may perform operations based on being executed by one or more processors, and the operations may include the operation method of the second device according to FIG. 29.

Claims set forth in various embodiments of the present disclosure may be combined in various schemes. For example, technical features of method claims of various embodiments of the present disclosure may be combined and implemented as a device, and technical features of device claims of various embodiments of the present disclosure may be combined and implemented as a method. Further, the technical features of the method claims and the technical features of the device claims of various embodiments of the present disclosure may be combined and implemented as the device, and the technical features of the method claims and the technical features of the device claims of various embodiments of the present disclosure may be combined and implemented as the method.

1. An operation method of a first device in a short-range wireless communication system, wherein the first device includes: a first processor corresponding to a host stack; a second processor corresponding to a first controller stack; a memory; and a transceiver, and the host stack and the controller stack are connected via a Host Controller Interface (HCI), the method comprising:
generating two second audio signals based on one first audio signal;
transmitting, to a second device, each of a plurality of first periodic audio signals consisting of two second audio signals and duplicate signals for the two second audio signals, sequentially from a first anchor point of a first interval at each sub-interval length; and
transmitting a human interface device (HID) signal to the second device repeatedly at each sub-interval length from a second time point at which an offset from the first anchor point has elapsed,
wherein each of the plurality of first periodic audio signals and the HID signal are not transmitted while being overlapped with each other.

2. The method of claim 1, wherein the offset corresponds to ½ of the sub-interval, and
wherein each of the plurality of first periodic audio signals is transmitted for a time period shorter than the offset.

3. The method of claim 1, wherein the first audio signal corresponds to ½ or more of the sub-interval, and
wherein each of the second audio signals and the duplicate signals corresponds to less than ½ of the sub-interval.

4. The method of claim 1, wherein the first interval is constituted by a plurality of first sub-intervals,
wherein each of the first sub-intervals corresponds to the sub-interval length, and
wherein the plurality of first periodic audio signals are constituted by a smaller number than the plurality of first sub-intervals.

5. The method of claim 4, wherein the plurality of first periodic audio signals are transmitted through first sub-intervals in an order corresponding to the number of plurality of first periodic audio signals, from a first first sub-interval among the plurality of first sub-intervals, and
wherein the plurality of first periodic audio signals are not transmitted in a last first sub-interval from a next first sub-interval following the first sub-interval in an order corresponding to the number of plurality of first periodic audio signals among the plurality of first sub-intervals.

6. The method of claim 4, wherein the HID signal is transmitted in all of the plurality of first sub-intervals.

7. The method of claim 1, wherein a second interval follows the first interval, and
wherein the plurality of first periodic audio signals and the HID signal are transmitted in the second interval similarly as in the first interval.

8. An operation method of a second device in a short-range wireless communication system, wherein the second device includes: a first processor corresponding to a host stack; a second processor corresponding to a second controller stack, a memory; and a transceiver, and the host stack and the controller stack are connected via a Host Controller Interface (HCI), the method comprising:
receiving, from a first device, each of a plurality of first periodic audio signals consisting of two second audio signals and duplicate signals for the two second audio signals, sequentially from a first anchor point of a first interval at each sub-interval length,
wherein the second audio signals are based on one first audio signal; and
receiving a human interface device (HID) signal from the first device repeatedly at each sub-interval length from a second time point at which an offset from the first anchor point has elapsed,
wherein each of the plurality of first periodic audio signals and the HID signal are not transmitted while being overlapped with each other.

9. The method of claim 8, wherein the offset corresponds to ½ of the sub-interval, and
wherein each of the plurality of first periodic audio signals is received for a time period shorter than the offset.

10. The method of claim 8, wherein the first audio signal corresponds to ½ or more of the sub-interval, and
wherein each of the second audio signals and the duplicate signals corresponds to less than ½ of the sub-interval.

11. The method of claim 8, wherein the first interval is constituted by a plurality of first sub-intervals,
wherein each of the first sub-intervals corresponds to the sub-interval length, and
wherein the plurality of first periodic audio signals are constituted by a smaller number than the plurality of first sub-intervals.

12. The method of claim 11, wherein the plurality of first periodic audio signals are received through first sub-intervals in an order corresponding to the number of plurality of first periodic audio signals, from a first first sub-interval among the plurality of first sub-intervals, and
wherein the plurality of first periodic audio signals are not received in a last first sub-interval from a next first sub-interval following the first sub-interval in an order corresponding to the number of plurality of first periodic audio signals among the plurality of first sub-intervals.

13. The method of claim 11, wherein the HID signal is received in all of the plurality of first sub-intervals.

14. The method of claim 8, wherein a second interval follows the first interval, and
wherein the plurality of first periodic audio signals and the HID signal received in the second interval similarly as in the first interval.

15. A first device in a short-range wireless communication system, the first device comprising:
a first processor corresponding to a host stack;
a second processor corresponding to a first controller stack;
a memory; and
a transceiver,
wherein the host stack and the controller stack are connected by a Host Controller Interface (HCI),
wherein the memory stores instructions for performing operations based on being executed by the first processor and the second processor, and
the operations include generating two second audio signals based on one first audio signal;
transmitting, to a second device, each of a plurality of first periodic audio signals consisting of two second audio signals and duplicate signals for the two second audio signals, sequentially from a first anchor point of a first interval at each sub-interval length; and
transmitting a human interface device (HID) signal to the second device repeatedly at each sub-interval length from a second time point at which an offset from the first anchor point has elapsed, and
wherein each of the plurality of first periodic audio signals and the HID signal are not transmitted while being overlapped with each other.

16. The first device of claim 15, wherein the offset corresponds to ½ of the sub-interval, and
wherein each of the plurality of first periodic audio signals is transmitted for a time period shorter than the offset.

17. The first device of claim 15, wherein the first audio signal corresponds to ½ or more of the sub-interval, and
wherein each of the second audio signals and the duplicate signals corresponds to less than ½ of the sub-interval.

18. The first device of claim 15, wherein the first interval is constituted by a plurality of first sub-intervals,
wherein each of the first sub-intervals corresponds to the sub-interval length, and
wherein the plurality of first periodic audio signals are constituted by a smaller number than the plurality of first sub-intervals.

19. The first device of claim 18, wherein the plurality of first periodic audio signals are transmitted through first sub-intervals in an order corresponding to the number of plurality of first periodic audio signals, from a first first sub-interval among the plurality of first sub-intervals, and
wherein the plurality of first periodic audio signals are not transmitted in a last first sub-interval from a next first sub-interval following the first sub-interval in an order corresponding to the number of plurality of first periodic audio signals among the plurality of first sub-intervals.

20. The first device of claim 18, wherein the HID signal is transmitted in all of the plurality of first sub-intervals.
